(19) United States
(12) Patent Application Publication
(10) Pub. No.: US 2021/0241172 A1
(43) Pub. Date: Aug. 5, 2021

(54) MACHINE LEARNING MODEL COMPRESSION SYSTEM, PRUNING METHOD, AND COMPUTER PROGRAM PRODUCT

(71) Applicant: KABUSHIKI KAISHA TOSHIBA, Minato-ku (JP)

(72) Inventors: Takahiro TANAKA, Akishima (JP); Kosuke HARUKI, Tachikawa (JP); Ryuji SAKAI, Hanno (JP); Akiyuki TANIZAWA, Kawasaki (JP); Atsushi YAGUCHI, Taito (JP); Shuhei NITTA, Ota (JP); Yukinobu SAKATA, Kawasaki (JP)

(73) Assignee: KABUSHIKI KAISHA TOSHIBA, Minato-ku (JP)

(21) Appl. No.: 17/002,820

(22) Filed: Aug. 26, 2020

(30) Foreign Application Priority Data
Feb. 5, 2020 (JP) 2020-017920

(51) Int. Cl. G06N 20/00; G06K 9/62

(52) U.S. Cl. CPC G06N 20/00; G06K 9/6228; G06K 9/6256

(57) ABSTRACT

A machine learning model compression system according to an embodiment includes one or more hardware processors configured to: select a layer of a trained machine learning model in order from an output side to an input side of the trained machine learning model; calculate, in units of an input channel, a first evaluation value evaluating a plurality of weights included in the selected layer; sort, in ascending order or descending order, the first evaluation values each calculated in units of the input channel; select a given number of the first evaluation values in ascending order of the first evaluation values; and delete the input channels used for calculation of the selected first evaluation values.

### CROSS-REFERENCE TO RELATED APPLICATIONS

This application is based upon and claims the benefit of priority from Japanese Patent Application No. 2020-017920, filed on Feb. 5, 2020; the entire contents of which are incorporated herein by reference.

### FIELD

Embodiments described herein relate generally to a machine learning model compression system, a pruning method, and a computer program product.

### BACKGROUND

Applications of machine learning, in particular deep learning, are being developed in various fields such as automated-driving, manufacturing process monitoring, and disease forecasting. Given these circumstances, compression technologies for machine learning models are receiving attention. In automated-driving, for example, real-time operation by an edge device with low processing capability and poor memory resources such as an in-vehicle image recognition processor is essential. Thus, the edge device with low processing capability and poor memory resources requires a small-scale model. Consequently, a technology for compressing a model while maintaining the recognition performance of a trained model as much as possible is required.

However, it is difficult for conventional technologies to appropriately select and prune channels near an output layer extracting more complicated features depending on a data set than near an input layer extracting simple shapes such as edge or texture.

### BRIEF DESCRIPTION OF THE DRAWINGS

FIG. 1 is a diagram of an exemplary functional configuration of a machine learning model compression system according to a first embodiment;

FIG. 2 is a diagram of an exemplary functional configuration of a pruning unit according to the first embodiment;

FIG. 3 is a flowchart of exemplary pruning processing according to the first embodiment;

FIG. 4 is a diagram for explaining the pruning processing according to the first embodiment;

FIG. 5 is a diagram illustrating an effect according to the first embodiment;

FIG. 6 is a diagram of an exemplary functional configuration of a machine learning model compression system according to a second embodiment;

FIG. 7 is a diagram of an exemplary functional configuration of an extraction controller according to the second embodiment;

FIG. 8 is a flowchart of an exemplary method of machine learning model compression according to the second embodiment;

FIG. 9 is a diagram of an exemplary functional configuration of a machine learning model compression system according to a third embodiment;

FIG. 10 is a flowchart of an exemplary method of machine learning model compression according to the third embodiment;

FIG. 11 is a diagram of an exemplary hardware configuration of a computer for use in the machine learning model compression systems of the first to third embodiments; and

FIG. 12 is a diagram of an exemplary apparatus configuration of the machine learning model compression systems of the first to third embodiment.

### DETAILED DESCRIPTION

A machine learning model compression system according to an embodiment of the present disclosure includes one or more hardware processors configured to: select a layer of a trained machine learning model in order from an output side to an input side of the trained machine learning model; calculate, in units of an input channel, a first evaluation value evaluating a plurality of weights included in the selected layer; sort, in ascending order or descending order, the first evaluation values each calculated in units of the input channel; select a given number of the first evaluation values in ascending order of the first evaluation values; and delete the input channels used for calculation of the selected first evaluation values.

The following describes embodiments of a machine learning model compression system, a pruning method, and a computer program product in detail with reference to the accompanying drawings.

### First Embodiment

The following describes an exemplary functional configuration of a machine learning model compression system according to a first embodiment.

Example of Functional Configuration

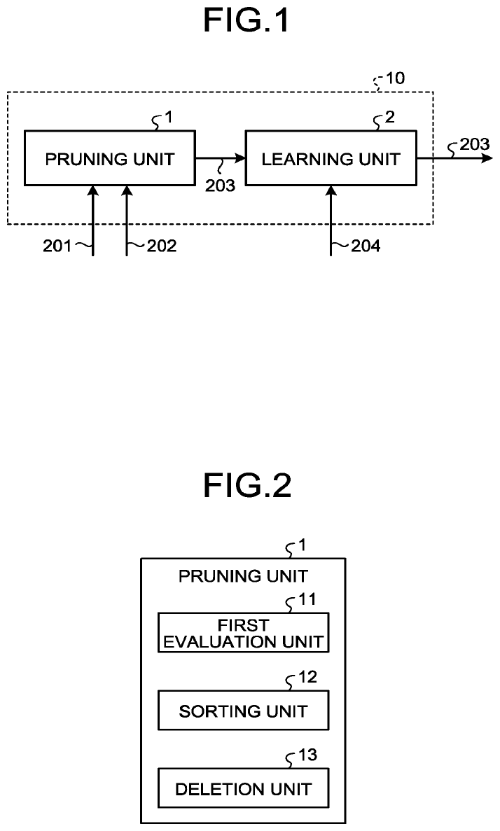

FIG. 1 is a diagram of an exemplary functional configuration of a machine learning model compression system 10 according to the first embodiment. The machine learning model compression system 10 according to the first embodiment includes a pruning unit 1 and a learning unit 2.

The pruning unit 1 executes pruning of weights of a trained machine learning model 202 based on pruning rates 201 of each input layer. In place of the pruning rates 201, the number of channels for each layer may be input to the pruning unit 1. Details of processing by the pruning unit 1 will be described below with reference to FIG. 2.

The learning unit 2 retrains a compressed model 203 generated by pruning by a data set 204 and outputs the retrained compressed model 203.

FIG. 2 is a diagram of an exemplary functional configuration of the pruning unit 1 according to the first embodiment. The pruning unit 1 according to the first embodiment includes a first evaluation unit 11, a sorting unit 12, and a deletion unit 13.

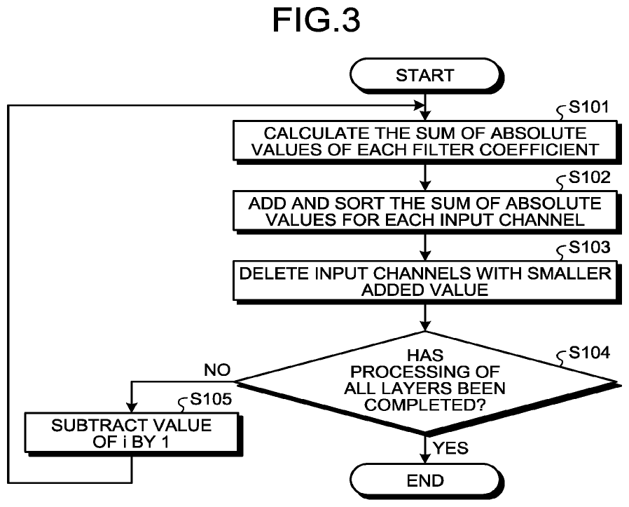

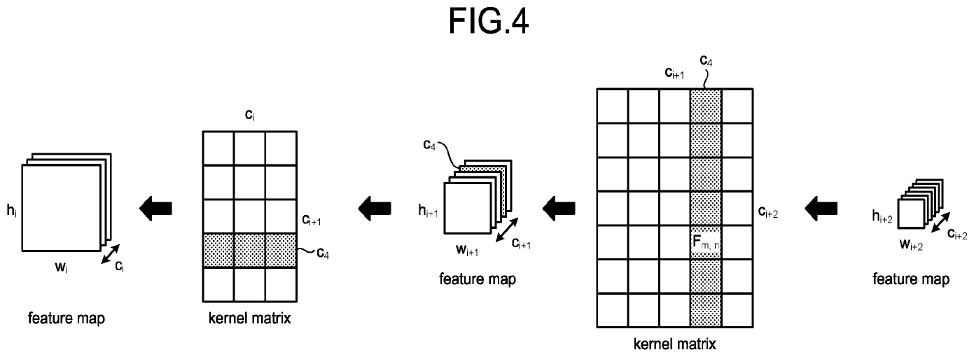

The first evaluation unit 11 selects a layer of the trained machine learning model 202 in order from an output side (an output layer) to an input side (an input layer) of the trained machine learning model 202, and calculates, in units of an input channel, a first evaluation value evaluating a plurality of weights included in the selected layer. Details of a method for calculating the first evaluation value will be described below with reference to FIG. 3 and FIG. 4.

The sorting unit 12 sorts the first evaluation values calculated in units of the input channel in ascending (or descending) order.

The deletion unit 13 selects a given number of the first evaluation values in ascending order of the first evaluation values, and deletes the input channels used for calculation of the selected first evaluation values.

Exemplary Pruning Processing

FIG. 3 is a flowchart of exemplary pruning processing according to the first embodiment. FIG. 4 is a diagram for explaining the pruning processing according to the first embodiment. In FIG. 4, “i” represents a layer number, “c” represents the number of channels, and “w” and “h” represent the width and the height, respectively, of a feature map. While a smaller value of “i” represents being nearer to the input layer, a larger value of “i” represents being nearer to the output layer. A number “n” of columns of a Kernel matrix corresponds to the number of input channels, and a number “m” of rows thereof corresponds to the number of output channels. The following describes a procedure pruning a filter from the (i+1)th layer. This processing is performed in order from the output layer to the input layer.

First, the first evaluation unit 11 calculates a sum of absolute values |K| of coefficients (weights) for each filter Fm,n (m=1 to cᵢ₊₁, n=1 to cᵢ₊₂) included in the Kernel matrix (Step S101). When each filter Fm,n is, for example, a 3×3 kernel, the sum of absolute values of the nine coefficients equals |K|. The sum of absolute values |K| is so-called an L1 norm. In place of the L1 norm, an L2 norm which is the sum of squares of the coefficients, an L∞ norm (max norm) which is the maximum value of the absolute values of the coefficients, or the like may be used.

The first evaluation unit 11 determines Sm for each input channel as the first evaluation value by Expression (1) below (Step S102).

Sₘ=Σₙ₌₁^{c}^{ᵢ₊₂}|K| (1)

The sorting unit 12 sorts Sm of the input channels in ascending order (or descending order) (Step S102).

The deletion unit 13 deletes a given number of the input channels having a smaller Sm and feature maps corresponding to the relevant input channels and, at the next layer, deletes output channels corresponding to the deleted feature maps (Step S103). The example in FIG. 4 illustrates a case in which the fourth channel c₄ and the feature map corresponding to the fourth channel c₄ are deleted.

Subsequently, the deletion unit 13 determines whether the pruning processing of all the layers has been completed (Step S104) When the pruning processing of all the layers is not completed (No at Step S104), the deletion unit 13 subtracts the value of “i” by 1 (Step S105), and the process returns to Step S101. When the pruning processing of all the layers is completed (Yes at Step S104), the pruning processing ends.

As described in the foregoing, in the machine learning model compression system according to the first embodiment, the first evaluation unit 11 selects the layer of the trained machine learning model 202 in order from the output side to the input side of the trained machine learning model 202, and calculates, in units of the input channel, the first evaluation value evaluating the weights included in the selected layer. The sorting unit 12 sorts the first evaluation values calculated in units of the input channel in ascending order (or descending order). The deletion unit 13 selects a given number of the first evaluation values in ascending order of the first evaluation values and deletes the input channels used for calculation of the selected first evaluation values.

With this configuration, by executing the pruning processing in order from the output layer to the input layer, it is possible to appropriately select the channels near the output layer extracting complicated features that depends on the data set 204. Thus, when the model after pruning is retrained, it is possible to advance convergence of training.

In general, a model after pruning is subjected to retraining by the target data set 204 in order to ensure recognition performance. The deletion unit 13 adjusts the given number at Step S103 to cause the recognition performance after retraining to fall under a tolerable reduction compared with the recognition performance before pruning.

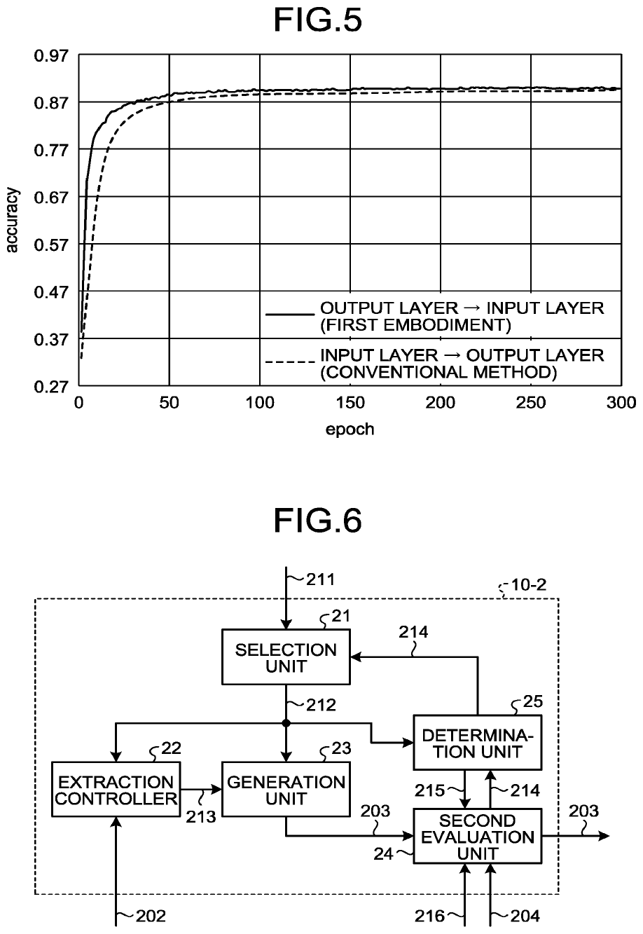

FIG. 5 is a diagram for illustrating an effect according to the first embodiment. FIG. 5 illustrates learning curves when machine learning models obtained by pruning the VGG-16 network trained by the CIFAR-10 data set by a conventional method described in Pruning Filters for Efficient ConvNets [Li 2017] (depicted with a dotted curve in FIG. 5) and the method according to the first embodiment (depicted with a solid curve in FIG. 5) and reducing the number of weights by about 1/10 were retrained by the CIFAR-10 data set. A horizontal axis in FIG. 5 represents learning time, and a vertical axis represents recognition performance. It is revealed that the recognition performance of the machine learning model pruned by the pruning method according to the first embodiment converges earlier.

In the first embodiment, when the number of weight parameters of the compressed model 203 desired to be generated is roughly determined in advance, search processing (details of which will be described below in a second embodiment) may be omitted to obtain a desired compressed model in a relatively short time.

### Second Embodiment

The following describes a machine learning model compression system according to the second embodiment. In the description according to the second embodiment, descriptions similar to those according to the first embodiment are omitted, and parts different from those according to the first embodiment are described. The second embodiment describes a case in which search processing for the compressed model 203 to be generated is executed.

Exemplary Functional Configuration

FIG. 6 is a diagram of an exemplary functional configuration of a machine learning model compression system 10-2 according to the first embodiment. The machine learning model compression system 10-2 according to the second embodiment includes a selection unit 21, an extraction controller 22, a generation unit 23, a second evaluation unit 24, and a determination unit 25.

The selection unit 21 executes parameter selection processing to select a parameter for determining a structure of a compressed model included in a given search space.

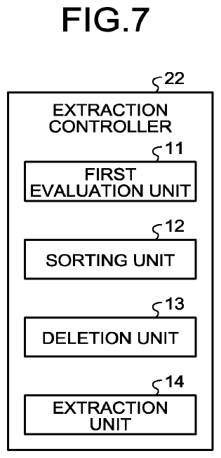

The extraction controller 22 executes weight extraction processing to extract weights of the compressed model from the trained machine learning model. Details of the processing by the extraction controller 22 will be described below with reference to FIG. 7.

The generation unit 23 executes compressed model generation processing to generate the compressed model 203 by using the parameter and to set the extracted weights as initial values of weights of at least one layer of the compressed model 203.

The second evaluation unit 24 executes performance evaluation processing to train the compressed model 203 for a given period and to calculate a second evaluation value representing recognition performance of the compressed model 203.

The determination unit 25 determines, based on a given end condition, whether to repeat the parameter selection processing described above, the weight extraction processing described above, the compressed model generation processing described above, and the performance evaluation processing described above.

FIG. 7 is a diagram of an exemplary functional configuration of the extraction controller 22 according to the second embodiment. The extraction controller 22 according to the second embodiment includes the first evaluation unit 11, the sorting unit 12, the deletion unit 13, and an extraction unit 14. Descriptions of the first evaluation unit 11, the sorting unit 12, and the deletion unit 13 are similar to those according to the first embodiment and are thus omitted. The extraction unit 14 extracts weights of the compressed model from the trained machine learning model (extracts remaining weights not being deleted) by deleting weights corresponding to the input channels deleted by the deletion unit 13.

Example of Machine Learning Model Compression Processing

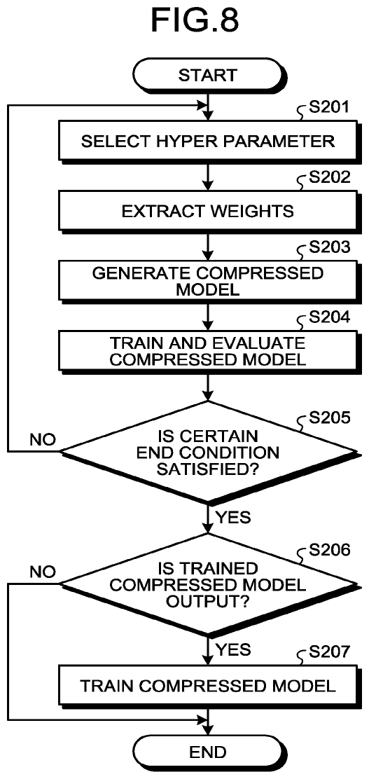

FIG. 8 is a flowchart of an exemplary method of machine learning model compression according to the second embodiment. First, the selection unit 21 selects a hyper parameter 212 including information on the number of channels (or the number of nodes) as a parameter determining a structure of the compressed model 203 included in a search space 211 (Step S201).

A specific method of selecting the compressed model 203 (the hyper parameter 212 determining a model structure of the compressed model 203) may be any method. The selection unit 21 may select the compressed model 203 expected to have higher recognition performance using Bayesian inference or a genetic algorithm, for example. The selection unit 21 may select the compressed model 203 by using random search or grid search, for example. The selection unit 21 may select a more optimum compressed model 203 by combining a plurality of methods of selection, for example.

The search space 211 may automatically be determined inside the machine learning model compression system 10-2. The search space 211 may automatically be determined by inputting the data set 204 used for the training of the trained machine learning model 202 to the trained machine learning model 202 and analyzing eigen values of each layer obtained by inference, for example.

Next, the extraction unit 14 extracts the number of weight parameters 213 corresponding to the information on the number of channels (or the number of nodes) included in the hyper parameter 212 from the trained machine learning model 202, by deleting the weights using the pruning method according to the first embodiment (refer to FIG. 3) (Step S202).

The generation unit 23 generates the compressed model 203 represented by the hyper parameter 212 selected at Step S201 and sets the weight parameters 213 extracted at Step S202 as initial values of the weights of the compressed model 203 (Step S203).

Next, the second evaluation unit 24 causes the compressed model 203 to train for a given period by using the data set 204, measures the recognition performance of the compressed model 203, and outputs a value representing recognition performance as a second evaluation value 214 (Step S204). The second evaluation value 214 is a value representing the recognition performance of the compressed model 203, such as “accuracy” for a class classification task or “mAP” for an object detection task.

For reducing a search time, the training may be discontinued when the second evaluation unit 24 determines that a much higher recognition performance is not expected to be gained from a training situation of the compressed model 203. Specifically, for example, the second evaluation unit 24 may evaluate an increase rate of a recognition performance corresponding to a learning time and discontinue the training when the increase rate is a threshold or less. With this configuration, search for the compressed model 203 can be made efficient.

The second evaluation unit 24 may determine execution of the processing at Step S204 based on a restriction condition 216 input to the machine learning model compression system 10-2. The restriction condition 216 represents a group of restrictions that must be satisfied when the compressed model 203 is operated. The restriction condition 216 is, for example, the upper limit of an inference speed (a processing time), the upper limit of memory usage, or the upper limit of the binary size of the compressed model 203. When the compressed model 203 does not satisfy the restriction condition 216, the processing at Step S204 is not performed, whereby the speed of search for the compressed model 203 can be increased.

Next, the determination unit 25 determines the end of search based on a given end condition set in advance (Step S205). The given end condition is, for example, a case that the second evaluation value 214 exceeds an evaluation threshold. Alternatively, the given end condition is a case that the number of times of evaluation by the second evaluation unit 24 (the number of times of evaluation of the second evaluation value 214) exceeds a number-of-times threshold. Alternatively, the given end condition is a case that the search time of the compressed model 203 exceeds a time threshold. The given end condition may be a combination of a plurality of end conditions, for example.

The determination unit 25 has held necessary information among the hyper parameter 212, the second evaluation value 214 corresponding to the hyper parameter 212, the number of times of loop, a search elapsed time, and the like in accordance with the end condition set in advance.

When the given end condition is not satisfied (No at Step S205), the determination unit 25 inputs the second evaluation value 214 to the selection unit 21, and the process returns to Step S201. Upon reception of the second evaluation value 214 described above from the determination unit 25, the selection unit 21 selects the hyper parameter 212 determining the model structure of the compressed model 203 to be processed next (Step S201).

On the other hand, if the given end condition is satisfied, (Yes at Step S205), the determination unit 25 inputs, as a selection model parameter 215, the hyper parameter 212 of the compressed model 203 whose second evaluation value 214 is the highest to the second evaluation unit 24.

When a trained compressed model 203 is output (Yes at Step S206), the second evaluation unit 24 causes the compressed model 203 determined by the selection model parameter 215 to sufficiently train by using the data set 204 (Step S207), and outputs the compressed model 203 as the trained compressed model 203.

The compressed model 203 output from the second evaluation unit 24 may be an untrained compressed model (No at Step S206) The information output from the second evaluation unit 24 may be a hyper parameter including information on the number of channels (or the number of nodes) of the compressed model 203, for example. The information output from the second evaluation unit 24 may be a combination of two or more of the untrained compressed model 203, the trained compressed model 203, and the hyper parameter, for example.

As described in the foregoing, in the second embodiment, part of the weights of the trained machine learning model 202 is set as the initial values of the weights of the compressed model 203, thereby advances convergence of training, and can reduce a learning time at the processing at Step S204. Thus, it is possible to efficiently search for the compressed model 203 that maximizes the recognition performance in the search space 211.

### Third Embodiment

The following describes a machine learning model compression system according to a third embodiment. In the description according to the third embodiment, descriptions similar to those according to the second embodiment are omitted. The third embodiment is different from the second embodiment in that, it can select, for each layer, whether or not to use the weights of the trained machine learning model 202 as the initial values of the weights of the compressed model 203.

Exemplary Functional Configuration

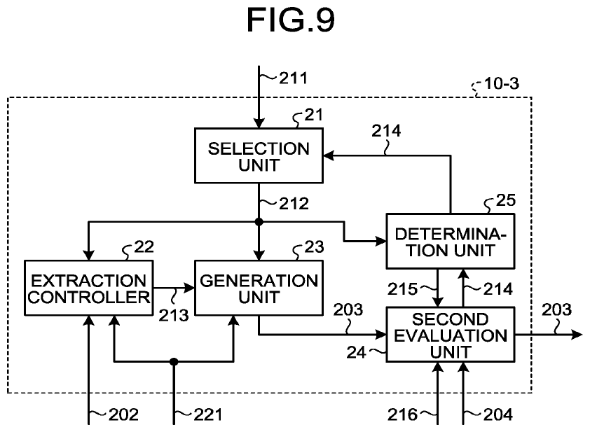

FIG. 9 is a diagram of an exemplary functional configuration of a machine learning model compression system 10-3 according to the third embodiment. The machine learning model compression system 10-3 according to the third embodiment includes the selection unit 21, the extraction controller 22, the generation unit 23, the second evaluation unit 24, and the determination unit 25.

The extraction controller 22 according to the third embodiment receives an input of designating one or more layers for which the extracted weights are set as the initial values of the weights of the compressed model (a weight setting parameter 221), and extracts the weights of the designated layers. The weight setting parameter 221 is set by a user, for example.

The generation unit 23 according to the third embodiment receives the input designating one or more layers setting the extracted weights as the initial values of the weights of the compressed model (the weight setting parameter 221) and sets the weights extracted by the extraction controller 22 as the initial values of the weights of the designated layers.

Example of Machine Learning Model Compression Processing

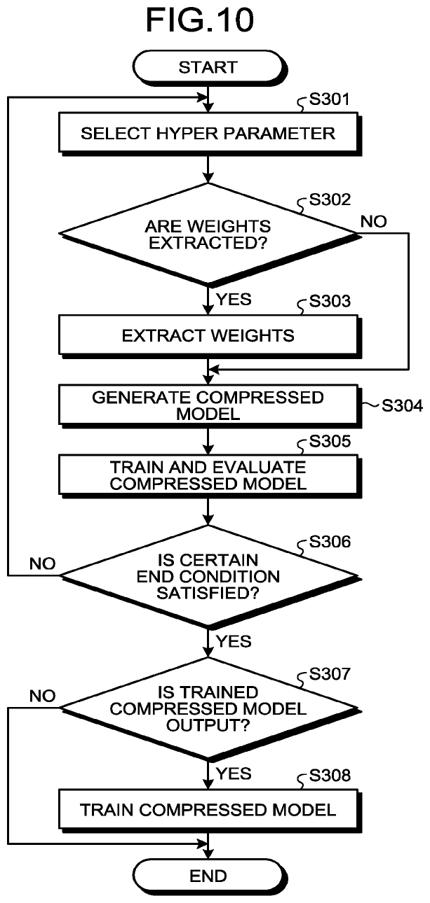

FIG. 10 is a flowchart of an exemplary method of machine learning model compression according to the third embodiment. A description of Step S301 is the same as that of Step S201 according to the second embodiment and is thus omitted.

The extraction controller 22 determines whether or not to extract the weights from the trained machine learning model 202 based on the weight setting parameter 221 described above (Step S302).

When the weights of the trained machine learning model 202 is used in at least one layer of the compressed model 203 (Yes at Step S302), the generation unit 23 sets the weight parameters 213 as the initial values of the weights of the layers of the compressed model 203 designated by the weight setting parameter 221 (Step S303). The initial values of the weights of the layers of the compressed model 203, which has not been designated by the weight setting parameter 221, may be random values or one or more given constant values.

When the weights of the trained machine learning model 202 are not used in all the layers of the compressed model 203 (No at Step S302), the process advances to Step S304.

Descriptions of Step S304 to Step S308 are the same as those of Step S203 to Step S207 according to the second embodiment and are thus omitted.

As described in the foregoing, in the third embodiment, it is possible to designate whether or not to use the weights of the trained machine learning model 202 for each layer, so that it can be fine-tuned to a data set different from the data set used for the training of the trained machine learning model 202. The weights of the trained machine learning model 202 are used only for the layers near the input layer extracting features that does not depend on the data set such as edge or texture, whereby the different data set can efficiently be fined-tuned, for example.

Finally, the following describes an exemplary hardware configuration of a computer for use in the machine learning model compression systems 10 to 10-3 of the first to third embodiments.

Example of Hardware Configuration

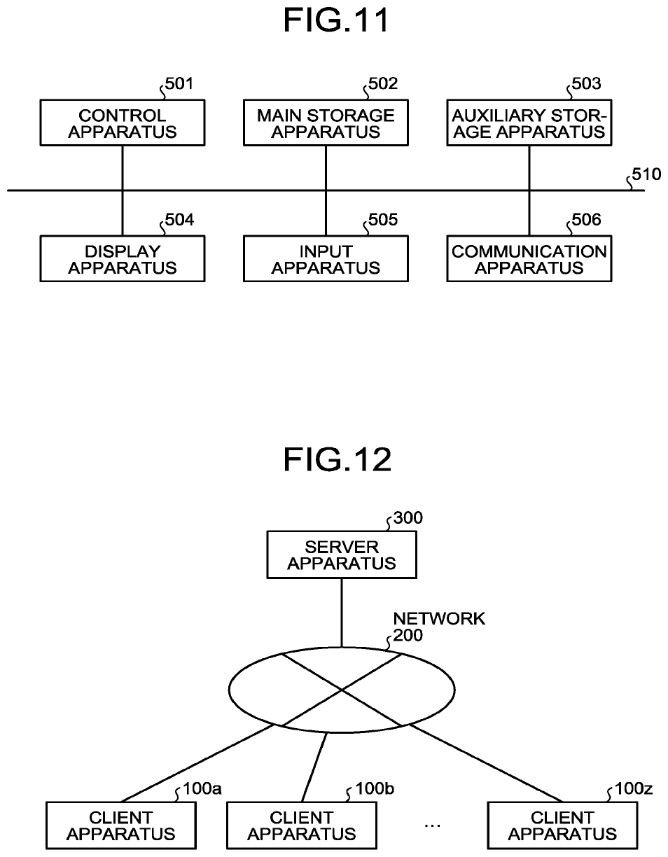

FIG. 11 is a diagram of the exemplary hardware configuration of the computer for use in the machine learning model compression systems 10 to 10-3 of the first to third embodiments.

The computer for use in the machine learning model compression systems 10 to 10-3 includes a control apparatus 501, a main storage apparatus 502, an auxiliary storage apparatus 503, a display apparatus 504, an input apparatus 505, and a communication apparatus 506. The control apparatus 501, the main storage apparatus 502, the auxiliary storage apparatus 503, the display apparatus 504, the input apparatus 505, and the communication apparatus 506 are connected to each other over a bus 510.

The control apparatus 501 executes a computer program read out from the auxiliary storage apparatus 503 to the main storage apparatus 502. The main storage apparatus 502 is a memory such as a read only memory (ROM) or a random access memory (RAM). The auxiliary storage apparatus 503 is a hard disk drive (HDD), a solid state drive (SSD), a memory card, or the like.

The display apparatus 504 displays display information. The display apparatus 504 is a liquid crystal display, for example. The input apparatus 505 is an interface for operating the computer. The input apparatus 505 is a keyboard or a mouse, for example. When the computer is a smart device such as a smartphone or a tablet terminal, the display apparatus 504 and the input apparatus 505 are a touch panel, for example. The communication apparatus 506 is an interface for communicating with other apparatuses.

The computer program executed by the computer is recorded on a computer-readable storage medium such as a compact disc read only memory (CD-ROM), a memory card, a compact disc recordable (CD-R), or a digital versatile disc (DVD) as an installable or executable file and is provided as a computer program product.

The computer program executed by the computer may be stored in a computer connected to a network such as the Internet and provided by being downloaded over the network. The computer program executed by the computer may be provided over a network such as the Internet without being downloaded.

The computer program executed by the computer may be embedded and provided in a ROM, for example.

The computer program executed by the computer has a module configuration including functional blocks implementable also by the computer program among the functional configuration (functional blocks) of the machine learning model compression systems 10 to 10-3 described above. The functional blocks, as actual hardware, are loaded onto the main storage apparatus 502 by reading the computer program from the storage medium and executing it by the control apparatus 501. That is to say, the functional blocks are generated on the main storage apparatus 502.

Part or the whole of the functional blocks described above may be implemented by hardware such as an integrated circuit (IC) without being implemented by software.

When the functions are implemented using a plurality of processors, each processor may implement one of the functions or implement two or more of the functions.

An operating mode of the computer implementing the machine learning model compression systems 10 to 10-3 may be any mode. The machine learning model compression systems 10 to 10-3 may each be implemented by one computer, for example. The machine learning model compression systems 10 to 10-3 may each be operated as a cloud system on a network, for example.

Example of Apparatus Configuration

FIG. 12 is a diagram of an exemplary apparatus configuration of the machine learning model compression systems 10 to 10-3 of the first to third embodiment. In the example in FIG. 12, the machine learning model compression systems 10 to 10-3 each include a plurality of client apparatuses 100a to 100z, a network 200, and a server apparatus 300.

When there is no need to discriminate the client apparatuses 100a to 100z from each other, they are referred to simply as a client apparatus 100. The number of client apparatuses 100 within the machine learning model compression systems 10 to 10-3 may be any number. The client apparatus 100 is a computer such as a personal computer or a smartphone, for example. The client apparatuses 100a to 100z and the server apparatus 300 are connected to each other over the network 200. A communication system of the network 200 may be a wired system, a wireless system, or a combination of both.

The pruning unit 1 and the learning unit 2 of the machine learning model compression system 10 may be implemented by, for example, the server apparatus 300 to be operated as a cloud system on the network 200. The client apparatus 100 may transmit the trained machine learning model 202 and the data set 204 to the server apparatus 300, for example. The server apparatus 300 may transmit the compressed model 203 retrained by the learning unit 2 to the client apparatus 100.

The selection unit 21, the extraction controller 22, the generation unit 23, the second evaluation unit 24, and the determination unit 25 of the machine learning model compression systems 10-2 and 10-3 may each be implemented by the server apparatus 300 to be operated as a cloud system on the network 200, for example. The client apparatus 100 may transmit the trained machine learning model 202 and the data set 204 to the server apparatus 300, for example. The server apparatus 300 may transmit the compressed model 203 searched for by a search unit 104 to the client apparatus 100.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A machine learning model compression system comprising
one or more hardware processors configured to:
select a layer of a trained machine learning model in order from an output side to an input side of the trained machine learning model;
calculate, in units of an input channel, a first evaluation value evaluating a plurality of weights included in the selected layer;
sort, in ascending order or descending order, the first evaluation values each calculated in units of the input channel;
select a given number of the first evaluation values in ascending order of the first evaluation values; and
delete the input channels used for calculation of the selected first evaluation values.

2. The system according to claim 1, wherein the first evaluation value is an L1 norm of the plurality of weights.

3. The system according to claim 1, wherein the one or more processors are further configured to:
execute parameter selection processing to select a parameter for determining a structure of a compressed model included in a given search space;
execute weight extraction processing to extract weights of the compression model from the trained machine learning model by deleting weights corresponding to the deleted input channels;
execute compressed model generation processing to generate the compressed model by using the parameter and to set the extracted weights as initial values of weights of at least one layer of the compressed model;
execute performance evaluation processing to train the compressed model for a given period and to calculate a second evaluation value representing recognition performance of the compressed model; and
determine, based on a given end condition, whether to repeat the parameter selection processing, the weight extraction processing, the compressed model generation processing, and the performance evaluation processing.

4. The system according to claim 3, wherein, in the compressed model generation processing, the one or more processors are configured to
receive an input of designating one or more layers for which the extracted weights are set as initial values of the weights of the compressed model, and
set the extracted weights as initial values of weights of the designated layers.

5. The system according to claim 3, wherein the given end condition is a case in which the second evaluation value exceeds an evaluation threshold, a case in which the number of times of evaluation of the second evaluation value exceeds a number-of-times threshold, or a case in which a search time of the compressed model exceeds a time threshold.

6. A pruning method implemented by a computer, the method comprising:
selecting a layer of a trained machine learning model in order from an output side to an input side of the trained machine learning model;
calculating, in units of an input channel, a first evaluation value evaluating a plurality of weights included in the selected layer;
sorting, in ascending order or descending order, the first evaluation values each calculated in units of the input channel;
selecting a given number of the first evaluation values in ascending order of the first evaluation value; and
deleting the input channels used for calculation of the selected first evaluation

7. A computer program product comprising a non-transitory computer-readable recording medium on which an executable program is recorded, the program instructing the computer to:
select a layer of a trained machine learning model in order from an output side to an input side of the trained machine learning model;
calculate, in units of an input channel, a first evaluation value evaluating a plurality of weights included in the selected layer;
sort, in ascending order or descending order, the first evaluation values each calculated in units of the input channel;
select a given number of the first evaluation values in ascending order of the first evaluation values; and
delete the input channels used for calculation of the selected first evaluation values.
